(19) United States
(12) Patent Application Publication
(10) Pub. No.: US 2024/0007576 A1
(43) Pub. Date: Jan. 4, 2024

(54) COATING BY OBJECT ON PRINTOUT

(71) Applicant: HEWLETT-PACKARD DEVELOPMENT COMPANY, L.P., Spring, TX (US)

(72) Inventor: Hannam KIM, Seongnam-si (KR)

(21) Appl. No.: 17/908,566

(22) PCT Filed: Nov. 12, 2020
(86) PCT No.: PCT/US2020/060126

§ 371 Date: Sep. 1, 2022

(30) Foreign Application Priority Data
May 27, 2020 (KR) 10-2020-0063376

(51) Int. Cl. H04N 1/387; H04N 1/00

(52) U.S. Cl. CPC H04N 1/3872; H04N 1/0044; H04N 1/00474; H04N 1/00482

(57) ABSTRACT

An example operating method of an image forming apparatus includes obtaining, based on a scan of a first printout, area information by type of object in the first printout, displaying, based on the area information obtained by type of the object, an execution screen for setting an area in which a coating job is to be performed, obtaining, based on a user input received through the execution screen, first coating-area information of an area in which a first coating job is to be performed within the first printout, and performing the first coating job on the first printout, according to the first coating-area information.

### BACKGROUND

In a case where a request to print a preset document or a preset file is received, an image forming apparatus converts digital data for the preset document or the preset file into an image containing preset information, and outputs the image as a printout.

### BRIEF DESCRIPTION OF THE DRAWINGS

FIG. 1 is a conceptual diagram for explaining an operation of performing a coating job for a printout, according to an example.

FIG. 2 is a flowchart illustrating an operating method of performing a coating job for a printout, according to an example.

FIG. 3 is a diagram for explaining a process of obtaining area information by object type, according to an example.

FIG. 4 is a diagram for explaining a process of generating a mask in which area information is identified by type of object, according to an example.

FIGS. 5A to 5C are diagrams for explaining an execution screen for setting an area in which a coating job is to be performed, according to an example.

FIG. 6 is a diagram for explaining a process of obtaining coating-area information of a first printout based on a coating area set in a printout in a preset format, according to an example.

FIG. 7 is a flowchart illustrating an operating method of recommending a coating job for a preset area based on read information obtained by a scan job performed on a printout, according to an example.

FIGS. 8A and 8B are diagrams for explaining a process of recommending a coating job for a preset area of a printout, and determining a coating area according to a user's input, according to an example.

FIGS. 9A and 9B are diagrams for explaining a process of performing a coating job based on coating-level information, according to an example.

FIG. 10 is a diagram for explaining an execution screen for displaying information guiding a mounting direction of a printout, according to an example.

FIG. 11 is a block diagram illustrating an image forming apparatus, according to an example.

FIG. 12 is a diagram for explaining instructions stored in a computer-readable storage medium, according to an example.

### DETAILED DESCRIPTION

Hereinafter, examples will be described with reference to the accompanying drawings. However, the disclosure may be implemented in various different forms and is not limited to the examples described herein.

An “image forming apparatus” may be any type of device capable of performing an image-forming job, such as a printer, a copier, a scanner, a fax machine, a multi-function printer (MFP), or a display device. Further, the image forming apparatus may be a two-dimensional (2D) image forming apparatus or a three-dimensional (3D) image forming apparatus. The “job performed in the image forming apparatus” may be a job related to printing, copying, scanning, faxing, storage, transmission, coating, or the like.

An example image forming apparatus may perform a preset coating job using a clear toner. An example image forming apparatus may output a printout in which a print job and a coating job for a given document are performed. In addition, an example image forming apparatus may perform a coating job on a preset area in the output printout. An example image forming apparatus may set an area to be coated in a printout and perform a coating job on the set area based on a user's input.

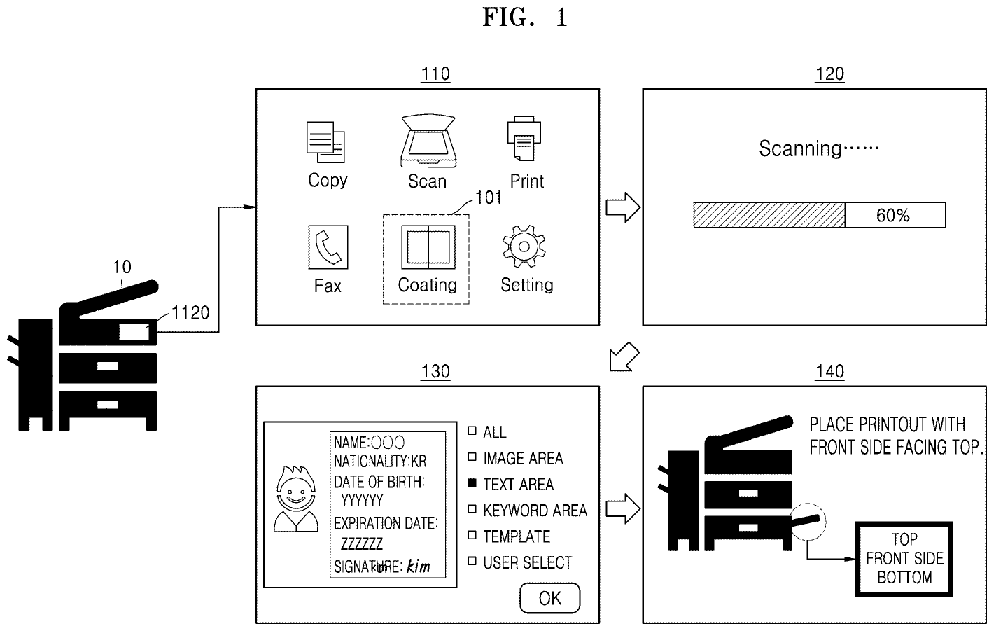

FIG. 1 is a conceptual diagram for explaining an operation of performing a printout coating job, according to an example.

Referring to an image 110 of FIG. 1, an image forming apparatus 10 may display icons for a job that may be performed by the image forming apparatus 10 through a user interface apparatus 1120. For example, the image forming apparatus 10 may display an icon for a copy job, an icon for a scan job, an icon for a print job, an icon for a fax job, an icon 101 for a coating job, an icon for settings, or the like. For example, the image forming apparatus 10 may receive an input for selecting the icon 101 for a coating job among a plurality of icons. The image forming apparatus 10 may display information for guiding a coating job.

Referring to an image 120 of FIG. 1, the image forming apparatus may perform a scan job on a first printout to perform a coating job. The image forming apparatus 10 may display the progress of the scan job through the user interface apparatus 1120 while the scan job of the first printout is being performed.

Referring to an image 130 of FIG. 1, the image forming apparatus may obtain identification information including type information of an object and area information in the first printout based on a scan job of the first printout. For example, the type information of the object may include information on a type such as an image, a text, a registered keyword, a registered image, a registered template, or the like. In addition, the area information of the object may include information about an area indicating an effective area of the object within the first printout.

For example, the image forming apparatus 10 may display an execution screen for setting an area in which a coating job is to be performed, based on the identification information of the object. For example, the execution screen may include a plurality of pieces of option information that may be selected to set an area where the coating job is to be performed. For example, the plurality of pieces of option information may include an item for all areas, an image area, a text area, a keyword area, a template area, a user select area, or the like. For example, the image forming apparatus 10 may receive an input for selecting the text area. The image forming apparatus 10 may set an area corresponding to the text area of the first printout as a coating area.

Referring to an image 140 of FIG. 1, the image forming apparatus may display information for guiding the mounting direction of the first printout for the coating job for the first printout. The user may place the first printout in a tray for a coating job by referring to the information that guides the mounting direction of the first printout. The image forming apparatus 10 may perform a coating job on the first printout based on the set coating area.

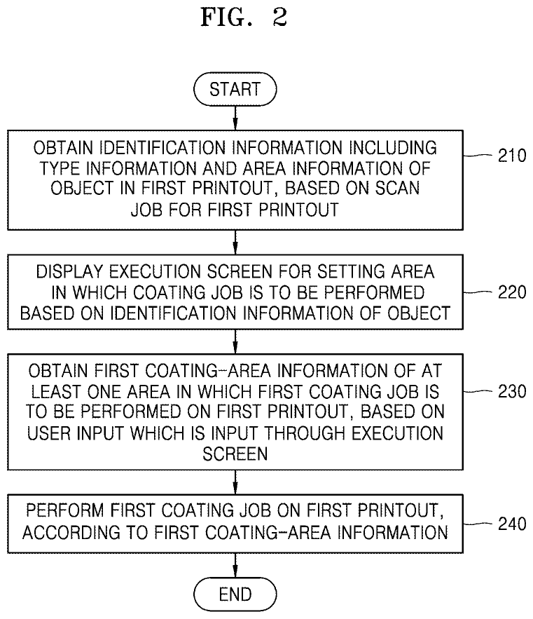

FIG. 2 is a flowchart illustrating an operating method of performing a coating job for a printout, according to an example.

Referring to FIG. 2, the image forming apparatus 10 may obtain identification information of an object in a first printout based on a scan job of the first printout in operation 210. For example, the identification information of the object may be information used to identify or detect the object. The identification information of an object may include object type information, area information, or the like.

For example, the type of the object may include an image, a text, a registered keyword, a registered image, or the like. For example, the area information of an object may include information about an area representing an effective area of the object within a printout. For example, in a case where images and text are included in the first printout, the image forming apparatus 10 may obtain the images and text as type information of an object of the first printout. In addition, the image forming apparatus 10 may obtain an area where an image is located in the first printout as area information of the image, and obtain an area where text is located in the first printout as area information of the text.

For example, the image forming apparatus 10 may display an icon for a copy job, an icon for a scan job, an icon for a print job, an icon for a fax job, and an icon for a coating job on a user interface apparatus of the image forming apparatus 10. In a case where an input for selecting the icon for a coating job is received, the image forming apparatus 10 may display guide information for the coating job. For example, the image forming apparatus 10 may display information requesting a scan job for the first printout in which the coating job is to be performed. The image forming apparatus 10 may perform a scan job on the first printout through a scanning apparatus.

For example, the image forming apparatus 10 may detect an object by type of object within the first printout, based on read information obtained by the scan job of the first printout. The image forming apparatus 10 may obtain, by object type, area information indicating an effective area of an object within the first printout.

As an example, the image forming apparatus 10 may change analog information of the first printout to digital information, based on a scan job of the first printout. The image forming apparatus 10 may obtain, by object type, area information corresponding to an object in the first printout by analyzing digital information of the first printout through an optical character recognition (OCR) reader in the image forming apparatus 10. For example, the OCR reader may refer to an apparatus to read text or the like recorded in a preset printout using light. In addition, a program having an OCR function may be installed in the image forming apparatus 10.

For example, the image forming apparatus 10 may analyze digital information of the first printout through OCR to detect, according to a type of a preset object, an effective area where the object is located, and obtain area information indicating information of the effective area where the object is located.

For example, the image forming apparatus 10 may detect an image area within the first printout and obtain first area information corresponding to the image area. In addition, the image forming apparatus 10 may detect a text area within the first printout and obtain second area information corresponding to the text area. In addition, the image forming apparatus 10 may detect a keyword area in the first printout and obtain third area information corresponding to the keyword area.

For example, the image forming apparatus 10 may generate, by object type, a mask in which area information is identified. For example, the image forming apparatus 10 may generate a first mask in which first area information corresponding to an image area is identified, a second mask in which second area information corresponding to a text area is identified, a third mask in which third area information corresponding to a keyword area is identified, etc. The image forming apparatus 10 may store a mask generated for each type of object.

In operation 220, the image forming apparatus 10 may display an execution screen for setting an area in which a coating job is to be performed, based on the identification information of the object.

For example, the image forming apparatus 10 may display a plurality of pieces of option information used for setting an area in which a first coating job is to be performed, based on the type information of the object.

The image forming apparatus 10 may display a plurality of pieces of option information, which may be used to set an area in which a coating job is to be performed, based on the object type information. For example, in a case where images and text are included in the first printout, the image forming apparatus 10 may provide optional information that may be selected to set the image area or the text area as an area in which the coating job is to be performed. In addition, in a case where a preset keyword is included in the first printout, the image forming apparatus 10 may provide optional information that may be selected to set the keyword area as an area in which a coating job is to be performed. In addition, in a case where the first printout is a printout in a preset format, the image forming apparatus 10 may provide optional information that may be selected to set a coating area set in a printout in a preset format as an area in which a coating job is to be performed.

The image forming apparatus 10 may display object-area information or an interface for setting an area on a preview image of the first printout. For example, the image forming apparatus 10 may display an area by object type on the preview image of the first printout. In addition, the image forming apparatus 10 may display an interface for setting an area in which the first coating job is to be performed on the preview image of the first printout.

For example, the image forming apparatus 10 may recommend a coating job on the first printout, based on read information obtained by a scan job of the first printout. An example process of recommending a coating job on a printout will be described with reference to FIG. 7.

In operation 230, the image forming apparatus 10 may obtain first coating-area information of an area in which a first coating job is to be performed within the first printout, based on a user input which is input through the execution screen.

For example, the image forming apparatus 10 may receive an input for selecting option information among a plurality of pieces of option information. The image forming apparatus 10 may obtain the first coating-area information of the first printout, based on an effective area identified as an area corresponding to the option information.

For example, in a case where more than one option information is selected, the image forming apparatus 10 may obtain a mask for each area of the object corresponding to the selected more than one option information. The image forming apparatus 10 may obtain first coating-area information of the first printout by combining the masks.

In operation 240, the image forming apparatus 10 may perform a first coating job on the first printout according to the first coating-area information.

For example, the image forming apparatus 10 may obtain first coating-level information for an area in which the first coating job is to be performed within the first printout. The first coating-level information may be information indicating a coating thickness for the area. The image forming apparatus 10 may perform a coating job on the first printout, based on the first coating-area information and the first coating-level information.

For example, the image forming apparatus 10 may display information guiding the mounting direction of the first printout. In a case where a printout is mounted on a tray for the coating job, the image forming apparatus 10 may perform a first coating job on the first printout, based on the first coating-area information.

The image forming apparatus 10 may set a preset area in the output printout as a coating area based on a user input and perform a coating job on the set coating area. By performing a coating job on a printout, the quality of the printout may be improved, and the retention period of the printout may also be improved. In addition, an image forming apparatus supporting print jobs and scan jobs may perform a coating job on a printout without additional hardware or a hardware change by using clear toner for the coating job.

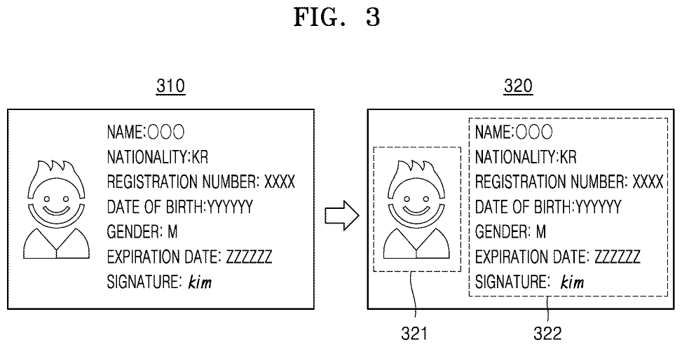

FIG. 3 is a diagram for explaining a process of obtaining area information by object type, according to an example.

Referring to FIG. 3, the image forming apparatus 10 may obtain area information for each type of object in a first printout, based on a scan job of the first printout. For example, the object type may be an image type, a text type, or the like. Further, the text type may include a pre-registered keyword type. In addition, the image type may include a pre-registered image type.

Referring to an image 310 of FIG. 3, the image forming apparatus may perform a scan job for the first printout including images and text. For example, the first printout may be a printout in which a user's identification card is printed. An image area of the first printout may include a picture of the user, and a text area of the first printout may include personal information of the user recorded as text.

Referring to an image 320 of FIG. 3, the image forming apparatus may change analog information in the first printout to digital information, based on a scan job of the first printout. The image forming apparatus 10 may detect, through OCR, an area 321 including a user's picture as an image area and an area 322 in which personal information of the user is located, as a text area. The image forming apparatus 10 may distinguishably store an image area and a text area.

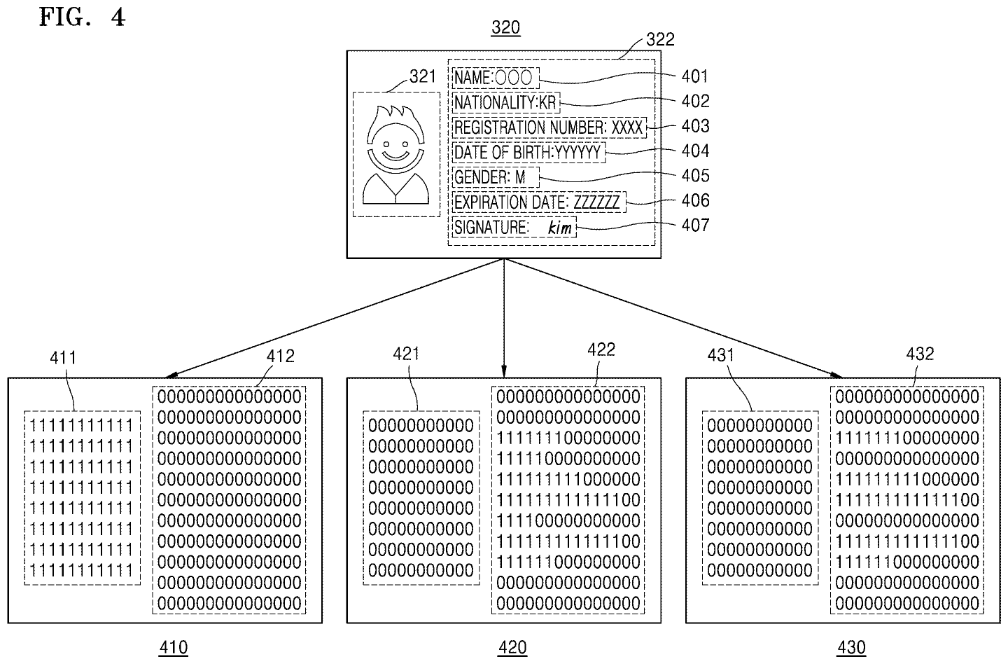

FIG. 4 is a diagram for explaining a process of generating a mask in which area information is identified by object type, according to an example.

Referring to FIG. 4, the image forming apparatus 10 may analyze digital information of a first printout through OCR, to detect, according to a type of a preset object, an effective area where the object is located, and obtain area information indicating information of the effective area where the object is located.

For example, the image forming apparatus 10 may analyze digital information of the first printout through OCR to detect an area identified as a text-recorded area as a text area, and an area not identified as a text-recorded area as an image area. In addition, the image forming apparatus 10 may detect an area in which a preset keyword is recorded among the text area as a keyword area. The image forming apparatus 10 may obtain first area information indicating location information of an image area, second area information indicating location information of a text area, and third area information indicating location information of a keyword area.

The image forming apparatus 10 may generate, by object type, a mask in which area information is identified. The image forming apparatus 10 may generate a first mask in which first area information corresponding to an image area is identified, a second mask in which second area information corresponding to a text area is identified, and a third mask in which third area information corresponding to a keyword area is identified. The image forming apparatus 10 may store a mask generated for each type of object.

As illustrated in an image 320 of FIG. 4, the image forming apparatus 10 may detect an area 322 including the user's personal information as a text area. The image forming apparatus 10 may distinguishably identify the user's personal information according to preset items. For example, preset items may include a name, a nationality, a registration number, a date of birth, a gender, an expiration date, a signature, or the like.

The image forming apparatus 10 may distinguishably identify an area including information corresponding to each preset item. For example, the image forming apparatus 10 may distinguishably identify the area 322, in which the user's personal information is recorded as text, as an area 401 including information corresponding to the name, an area 402 including information corresponding to the nationality, an area 403 including information corresponding to the registration number, an area 404 including information corresponding to the date of birth, an area 405 including information corresponding to the gender, an area 406 including information corresponding to the expiration date, and an area 407 including information corresponding to the signature.

The image forming apparatus 10 may generate, by object type, a mask in which area information is identified. For example, as shown in an image 410 of FIG. 4, the image forming apparatus 10 may generate a first mask in which first area information corresponding to the image area is identified. For example, the image forming apparatus 10 may store a first area 411 of the first mask corresponding to the area 321 containing the user's picture as “1,” and store a second area 412 of the first mask corresponding to the area 322 in which the user's personal information is recorded as text as “0.”

For example, as shown in an image 420 of FIG. 4, the image forming apparatus 10 may generate a second mask in which second area information corresponding to the text area is identified. For example, the image forming apparatus 10 may store a first area 421 of the second mask corresponding to the area 321 containing the user's picture as “0,” and store a third area of the second mask corresponding to the area 322 in which the user's personal information is recorded as text as “1.” The third area of the second mask is an area corresponding to areas 401, 402, 403, 404, 405, 406, and 407 of the image 320 in a second area 422 of the second mask.

For example, as shown in an image 430 of FIG. 4, the image forming apparatus 10 may generate a third mask in which third area information corresponding to a keyword area is identified. For example, the keyword may be name, registration number, date of birth, expiration date, and signature. The areas corresponding to the keyword area may be areas 401, 403, 404, 406, and 407 including information of name, registration number, date of birth, expiration date, and signature. For example, the image forming apparatus 10 may store a first area 431 of the third mask corresponding to the area 321 containing the user's picture as “0,” and store a third area of the third mask corresponding to the keyword area as “1.” The third area of the third mask is an area corresponding to the areas 401, 403, 404, 406, and 407 of the image 320, in a second area 432 of the third mask.

The image forming apparatus 10 may store a first mask, a second mask, a third mask, etc. generated by object type.

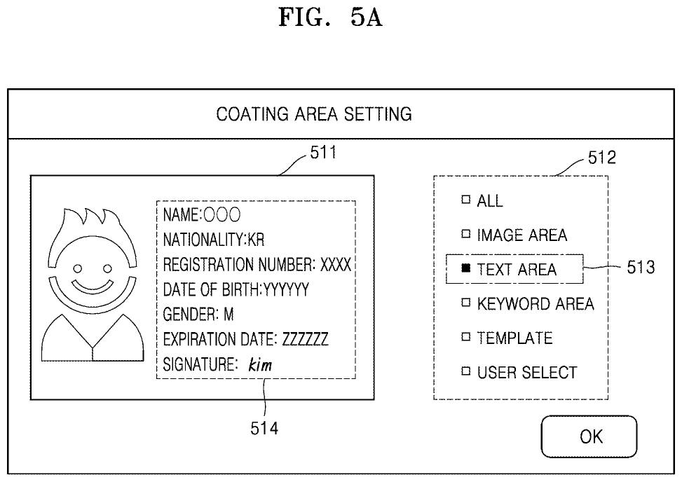

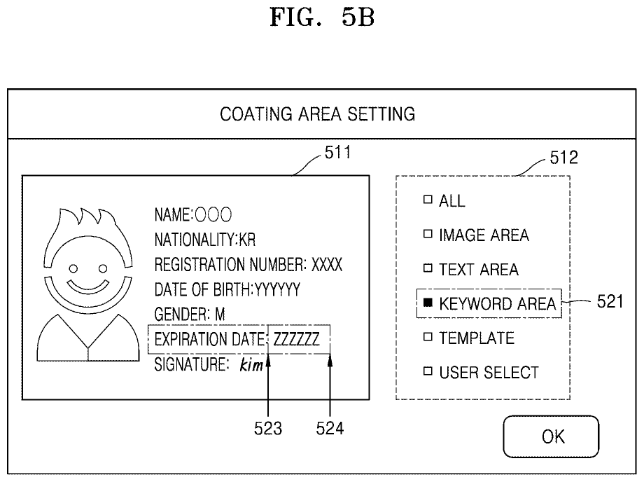

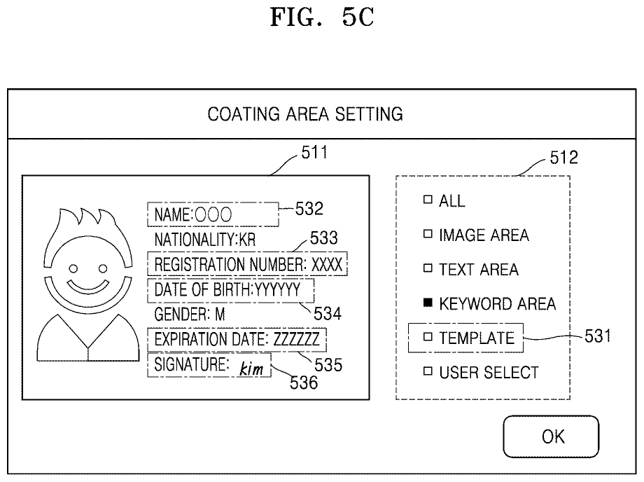

FIGS. 5A to 5C are diagrams for explaining an execution screen for setting an area in which a coating job is to be performed, according to an example.

Referring to FIG. 5A, the image forming apparatus 10 may display an execution screen for setting an area in which a coating job is to be performed. The execution screen may include therein a preview image 511 of a first printout in which a coating job is to be performed, and a plurality of pieces of option information 512, each selectable as an area in which a coating job is to be performed. The plurality of pieces of option information 512 may include an item such as all areas, an image area, a text area 513, a keyword area, a template area, and a user select area.

For example, the image forming apparatus 10 may receive an input for selecting the text area 513 among the plurality of pieces of option information 512. In a case where an input for selecting the text area 513 is received, the image forming apparatus 10 may identifiably display an area 514 corresponding to the text area in the preview image 511. For example, the area 514 corresponding to the text area may be identifiably displayed by a dotted line. In a case where an input for selecting an “OK” button is received through the execution screen, the image forming apparatus 10 may set the area 514 corresponding to the text area in the first printout as a coating area.

Referring to FIG. 5B, the image forming apparatus 10 may receive an input for selecting a keyword area 521 among the plurality of pieces of option information 512. For example, the keyword may be an expiration date. In a case where an input for selecting the keyword area 521 is received, the image forming apparatus 10 may identifiably display areas 523 and 524 corresponding to the keyword area in the preview image 511. For example, the areas 523 and 524 corresponding to the keyword area may be identifiably displayed by dotted lines.

In a case where an area corresponding to an area of an expiration date set as a keyword is identifiably displayed as an area 523, the image forming apparatus 10 may expand the area 523 to an area 524 based on a user input. In addition, the image forming apparatus 10 may display an area corresponding to “ZZZZZZ” indicating an expiration date as an area corresponding to the keyword area, based on a user input.

In a case where an input for selecting the “OK” button is received through the execution screen, the image forming apparatus 10 may set the areas 523 and 524 corresponding to the keyword area in the first printout as a coating area.

Referring to FIG. 5C, the image forming apparatus 10 may receive an input for selecting a template 531 among the plurality of pieces of option information 512. For example, a first printout to which an identification card is output may be a printout in a preset format. In the identification card, areas corresponding to a name, a registration number, a date of birth, an expiration date, a signature, or the like may be preset as a coating area. In a case where an input to select the template 531 is received, the image forming apparatus 10 may identifiably display areas 532, 533, 534, 535, and 536 corresponding to a coating area preset in the template, in the preview image 511. For example, the areas 532, 533, 534, 535, and 536 corresponding to the coating area preset in the template may be identifiably displayed by dotted lines. In a case where an input to select the “OK” button is received through the execution screen, the image forming apparatus 10 may set the areas 532, 533, 534, 535, and 536 corresponding to a template area in the first printout as a coating area.

In an example, the image forming apparatus 10 may receive an input for selecting user select among the plurality of pieces of option information 512. In that case, the user can optionally set a coating area in the preview image 511. The image forming apparatus 10 may set a coating area to be coated in the first printout, based on a user's input.

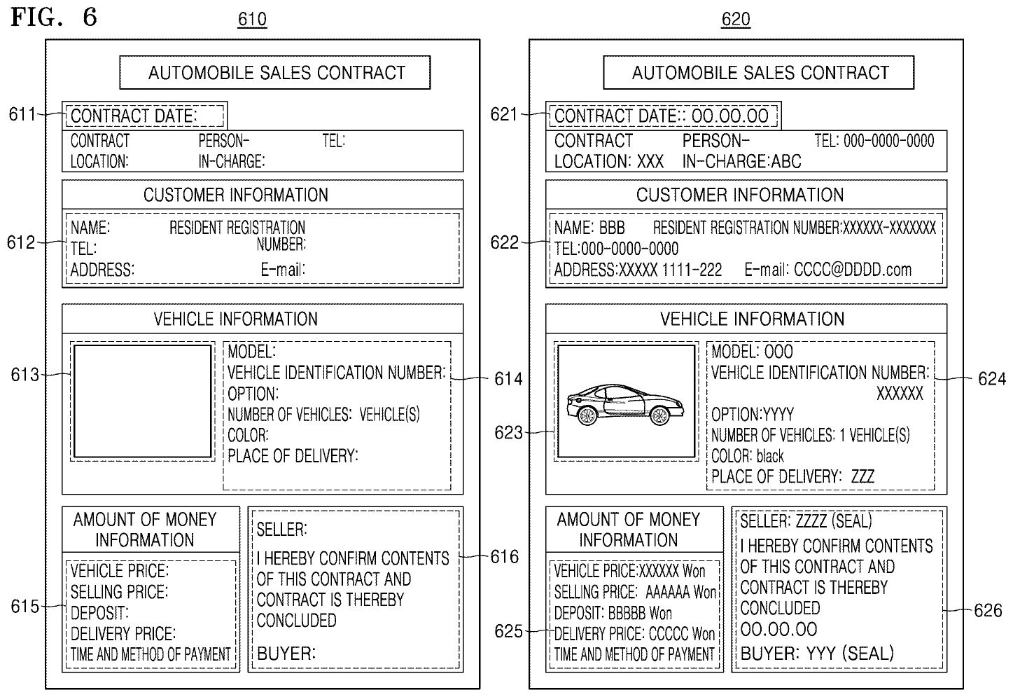

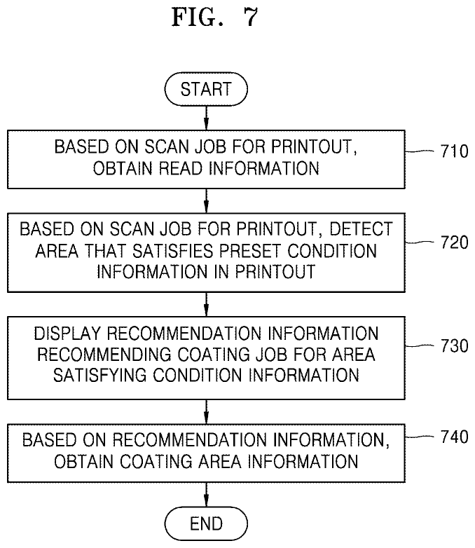

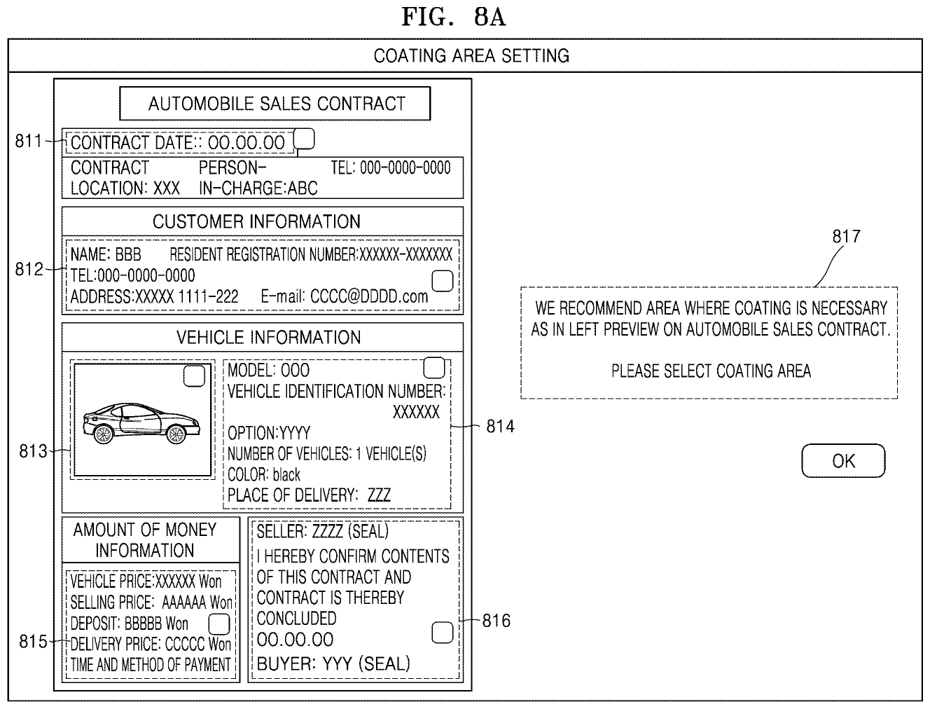

FIG. 6 is a diagram for explaining a process of obtaining coating-area information of a first printout based on a coating area set in a printout in a preset format, according to an example.

Referring to an image 610 of FIG. 6, the image forming apparatus may register an “automobile sales contract” as a printout in a preset format, based on a user input. In this case, the image forming apparatus 10 may set a basic coating area in which a coating job is to be performed in the “automobile sales contract,” based on a user input.

For example, the image forming apparatus 10 may set, based on a user input, an area among an area 611 for describing the contract date, an area 612 for describing customer information, areas 613 and 614 for describing vehicle information, an area 615 for describing the amount of money information, and an area 616 for describing information of the seller and the buyer, as a basic coating area in which a coating job is performed.

For example, the image forming apparatus 10 may scan the “automobile sales contract” and display a preview image for the “automobile sales contract.” The image forming apparatus 10 may receive an input for setting a basic coating area in which a coating job is performed in the “automobile sales contract,” through the preview image.

Referring to an image 620 of FIG. 6, the image forming apparatus 10 may perform an operation for coating the first printout on which the “automobile sales contract” is written. In a case where a scan job of the first printout in which the “automobile sales contract” is written is performed, the image forming apparatus 10 may obtain area information for each type of object in the first printout.

In a case where it is confirmed that the first printout is registered as a preset format of “automobile sales contract,” the image forming apparatus 10 may include a “template” item in an option for setting a coating area. In a case where an input to select the “template” item is received, the image forming apparatus 10 may set, in the first printout, areas 621, 622, 623, 624, 625, and 626 corresponding to the basic coating areas 611, 612, 613, 614, 615, and 616 of the “automobile sales contract” as a coating area.

In addition, in a case where it is confirmed that the first printout is registered as a preset format of “automobile sales contract,” the image forming apparatus 10 may automatically set, in the first printout, the areas 621, 622, 623, 624, 625, and 626 each corresponding to basic coating areas 611, 612, 613, 614, 615, and 616 of the “automobile sales contract” as coating areas.

FIG. 7 is a flowchart illustrating an operating method of recommending a coating job for a preset area based on read information obtained by a scan job performed on a printout, according to an example.

Referring to FIG. 7, the image forming apparatus 10 may obtain read information, based on a scan job of a printout, in operation 710.

For example, the image forming apparatus 10 may obtain analog information of the printout, based on the scan job of the printout. The image forming apparatus 10 may change analog information of the printout into digital information of the printout. The image forming apparatus 10 may analyze digital information of the printout through OCR, and obtain, based on the analyzed digital information of the printout, read information indicating information included in the printout.

For example, the information included in the printout may include information about the format of the printout and information about the contents of the printout. For example, the information about the format of the printout may include information about whether the printout includes an image, information about an image area included in the printout, information about whether the printout includes text, information about a text area included in the printout, or the like. For example, the information about the contents of the printout may include information about whether an image included in the printout matches a registered image, information about the meaning of an image included in the printout, information about whether text included in the printout matches registered text, information about the meaning indicated by the text included in the printout, or the like.

In operation 720, the image forming apparatus 10 may detect an area that satisfies preset condition information in the printout, based on the read information.

For example, the preset condition information may be information on a condition for detecting an area in which a coating job is to be performed in the printout.

For example, the preset condition information may include a condition for detecting an image area in the printout, a condition for detecting a text area in the printout, a condition for detecting an area corresponding to a preset keyword in the printout, a condition for detecting a preset area of a template registered in the printout, a condition for detecting an area corresponding to a preset image in the printout, or the like.

For example, in a case where the preset condition information is a condition for detecting a text area in the printout, the image forming apparatus 10 may detect the text area in the printout, based on the read information of the printout.

In operation 730, the image forming apparatus 10 may display recommendation information recommending a coating job for an area that satisfies condition information.

For example, the image forming apparatus 10 may display an area that satisfies condition information to be identified, in a preview image of the printout. For example, the image forming apparatus 10 may display an area that satisfies the condition information with a dotted line, a solid line, a color, an indicator, or the like.

For example, in a case where there are a plurality of areas satisfying the condition information, the image forming apparatus 10 may display a screen that provides an interface through which the user may select each of the plurality of areas.

In operation 740, the image forming apparatus 10 may obtain coating-area information, based on recommendation information.

For example, the image forming apparatus 10 may determine a coating area of the printout, based on recommendation information selected by a user from among the recommendation information.

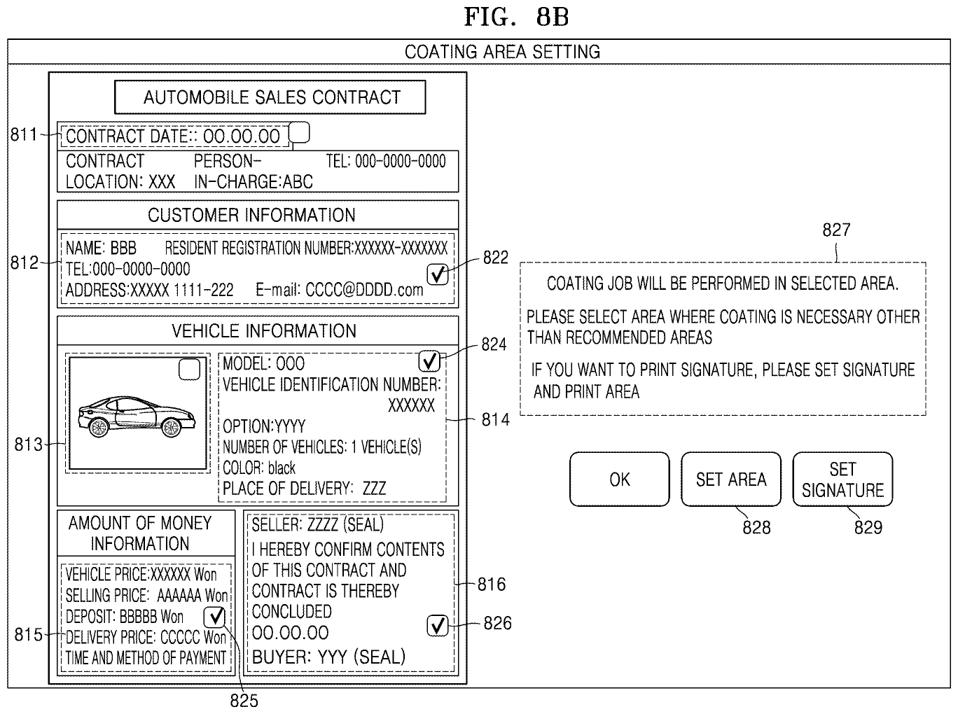

FIGS. 8A and 8B are diagrams for explaining a process of recommending a coating job for a preset area of a printout, and determining a coating area according to a user's input, according to an example.

FIG. 8A is a diagram to explain a process of recommending a coating job to a preset area of a printout, based on read information obtained by an image forming apparatus 10 by a printout scan job, according to an example.

Referring to FIG. 8A, the image forming apparatus 10 may obtain first read information of “automobile sales contract,” based on a scan job of the “automobile sales contract.” For example, the first read information may include information on a contract date, information on a contract location, information on a person in charge, customer information, vehicle information, money information, information on the seller and the buyer, or the like.

The image forming apparatus 10 may detect an area satisfying preset first condition information in the “automobile sales contract,” based on the first read information.

For example, the first condition information may include information about a condition for detecting an area of an item set as an item to be considered in an automobile sales contract. For example, items to be considered in an automobile sales contract may include information on a contract date, customer information, vehicle information, money information, seller and buyer information, or the like.

For example, an item set as an item to be considered in an automobile sales contract may be preset by a user, or may be set based on history information set as a coating area in a contract of the same or similar type to an automobile sales contract in the image forming apparatus 10.

The image forming apparatus 10 may detect, based on the first read information and the first condition information, areas corresponding to the information of the contract date, the customer information, the money information, the seller and buyer information in the “automobile sales contract,” or the like, and may obtain information about the areas.

As shown in FIG. 8A, the image forming apparatus 10 may identifiably display an area 811 corresponding to contract date information, an area 812 corresponding to customer information, areas 813 and 814 corresponding to vehicle information, an area 815 corresponding to money information, and an area 816 corresponding to information of the seller and the buyer in the preview image of the “automobile sales contract.” For example, the image forming apparatus 10 may identifiably display the areas 811, 812, 813, 814, 815, and 816 using dotted lines, and display checkboxes for selecting the areas 811, 812, 813, 814, 815, and 816.

The image forming apparatus 10 may display recommendation information recommending a coating job for an area that satisfies first condition information. For example, the image forming apparatus 10 may display a message 817 such as “We recommend areas where coating is necessary as in the left preview on the automobile sales contract. Please select a coating area.”

The image forming apparatus 10 may receive an input for selecting an area among the areas 811, 812, 813, 814, 815, and 816 recommended in the preview image of the “automobile sales contract.” For example, the image forming apparatus 10 may receive an input for selecting the areas 812, 814, 815, and 816. Thereafter, in a case where an input for selecting “OK” is received on the coating area setting screen of FIG. 8A, the image forming apparatus 10 may display a screen for confirming the setting of the coating area.

FIG. 8B is a diagram to explain a process where the image forming apparatus 10 determines a coating area based on a user's input which has been input according to the recommendation information, according to an example.

The image forming apparatus 10 may display the areas 812, 814, 815, and 816 selected by the user among the areas 811, 812, 813, 814, 815, and 816 recommended in the preview image of the “automobile sales contract.” For example, the image forming apparatus 10 may display the checkboxes 822, 824, 825, and 826 respectively corresponding to the areas 812, 814, 815, and 816 in the preview image of the “automobile sales contract” in a marked state.

In addition, the image forming apparatus 10 may display a message 827 including information of confirmation on the setting of the coating area, additional setting of the coating area, and additional print setting of the signature. The image forming apparatus 10 may provide an “area setting” button 828 for additional setting of the coating area, and a “signature setting” button 829 for additional print setting of the signature.

For example, in a case where an input for selecting the “area setting” button 828 is received, the image forming apparatus 10 may set an additional area to be coated on the “automobile sales contract,” based on a user's input.

For example, in a case where an input for selecting the “signature setting” button 829 is received, the image forming apparatus 10 may set a signature to be printed on the “automobile sales contract” and a location in which the signature is to be printed, based on a user's input.

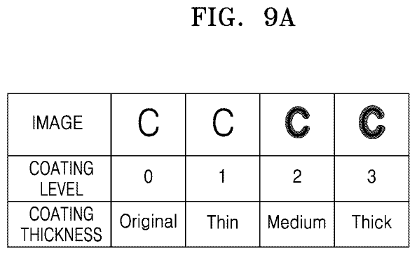

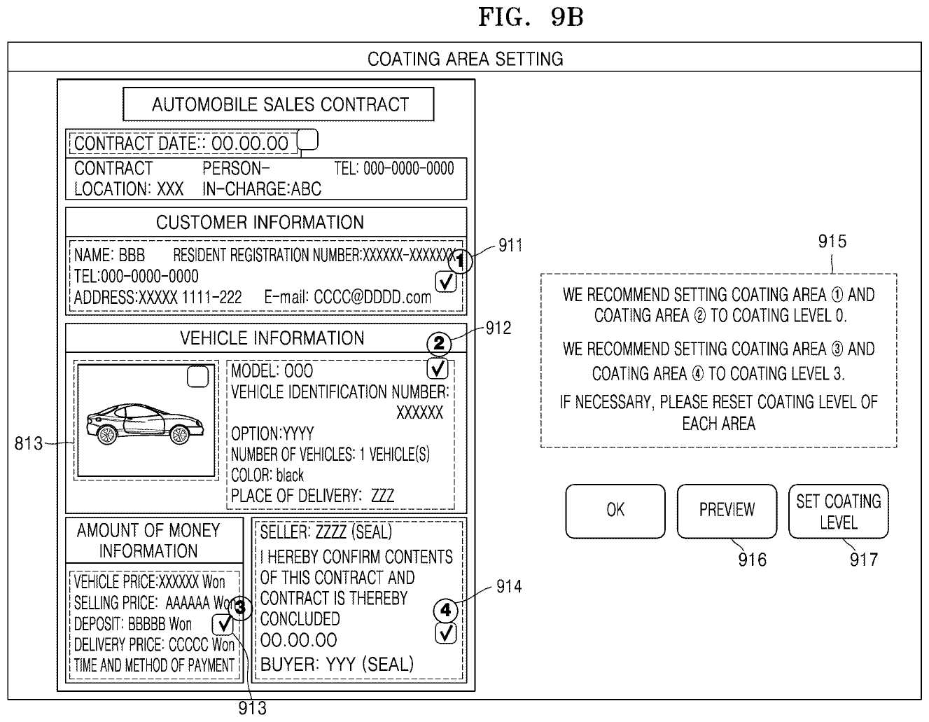

FIGS. 9A and 9B are diagrams for explaining a process of performing a coating job based on coating-level information, according to an example.

FIG. 9A is a table to explain a coating thickness according to coating-level information, according to an example.

The image forming apparatus 10 may obtain coating-level information for an area in which a coating job is to be performed within a printout. For example, coating-level information may include information indicating a coating thickness for an area. For example, in a case where the coating level is 0, the coating thickness may be a thickness that matches the thickness of the coating area of the printout. In a case where the coating level is 0, the coating thickness may be displayed as original. In addition, in a case where the coating level is 1, the coating thickness may be thinner by a preset value than the thickness of the coating area of the printout. In a case where the coating level is 1, the coating thickness may be displayed as thin. In addition, in a case where the coating level is 2, the coating may be thicker than the coating area of the printout by a preset value. In a case where the coating level is 2, the coating thickness may be displayed as medium. Further, in a case where the coating level is 3, the coating may be thicker by more than a preset value than the coating area of the printout. In a case where the coating level is 3, the coating thickness may be displayed as thick.

For example, in a case where an area includes a plurality of areas, the image forming apparatus 10 may set a coating level for each of the plurality of areas, based on a user's input. The image forming apparatus 10 may perform a coating job on a printout, based on coating-area information and coating-level information. For example, in a case where a first coating area is set to the coating level 3, the image forming apparatus 10 may perform a coating job with the thickness of the first coating area exceeding a preset value.

In an example, the image forming apparatus 10 may provide a paid service for the coating job for a printout. The paid service may vary in cost depending on the coating level. For example, for a preset area, the cost for performing the coating job at the coating level 3 may be higher than the costs for performing the coating job at the coating levels 0, 1, and 2. As another example, for a preset area, the cost for performing the coating job at the coating level 2 may be higher than the costs for performing the coating job at the coating levels 0 and 1.

FIG. 9B is a diagram to explain a process of recommending a coating thickness for a coating area in which a coating job is to be performed, according to an example.

The image forming apparatus 10 may determine the level of information included in a coating area determined as the area where a coating job is to be performed. The image forming apparatus 10 may determine coating-level information of the coating area based on level information of the information included in the coating area. The image forming apparatus 10 may display recommendation information for performing a coating job according to coating-level information of the coating area.

For example, the level of information may be determined based on attribute information of a printout and information about a preset item in a printout. For example, in the “automobile sales contract,” money information and seller and buyer information may be information about a preset item.

As shown in FIG. 9B, the image forming apparatus 10 may display numerical information allocated to each coating area in a preview image of the “automobile sales contract.” For example, \textcircled{1} may be allocated to an area corresponding to the customer information, and may be displayed as numerical information 911. In addition, \textcircled{2} may be allocated to an area corresponding to the vehicle information, and may be displayed as numerical information 912. In addition, \textcircled{3} may be allocated to an area corresponding to the money information, and may be displayed as numerical information 913. In addition, \textcircled{4} may be allocated to an area corresponding to the seller's and buyer's information, and may be displayed as numerical information 914.

The image forming apparatus 10 may display a message 915 to recommend setting of the coating level of the areas corresponding to the preset item, money information and seller and buyer information, to 3, and recommend setting of the coating level of the areas corresponding to customer information and vehicle information to 0.

In addition, the image forming apparatus 10 may provide a “Preview” button 916 that provides a preview of the coating area of the printout on which a coating job has been completed, and a “Set coating level” button 917 for setting a coating level.

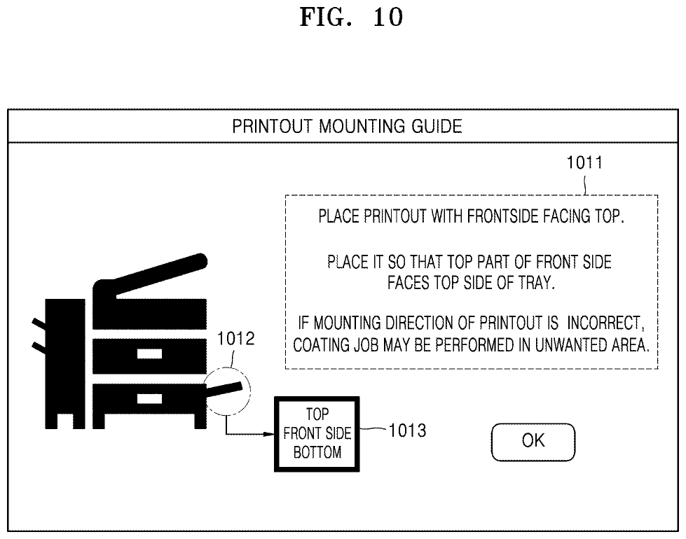

FIG. 10 is a diagram for explaining an execution screen for displaying information guiding a mounting direction of a printout, according to an example.

Referring to FIG. 10, in a case where a coating area in which the coating job is to be performed in the printout is determined, the image forming apparatus 10 may display information guiding the mounting direction of the printout for the coating job for the printout. For example, the image forming apparatus 10 may display information guiding information about a direction in which a printout is to be placed on a tray for a coating job.

For example, the image forming apparatus 10 may display guide information including front-and-back direction information of a printout and up-and-down direction information of a printout. The guide information may be provided as images and messages. For example, the image forming apparatus 10 may display a message 1011 such as “Place the printout with the front side facing top. Place it so that the top part of the front side faces the top side of the tray. If the mounting direction of the printout is incorrect, the coating job may be performed on an unwanted area.”

In addition, the image forming apparatus 10 may display, through an image, information 1012 indicating a mounting location for a coating job for a printout, and information 1013 indicating a mounting direction of the printout.

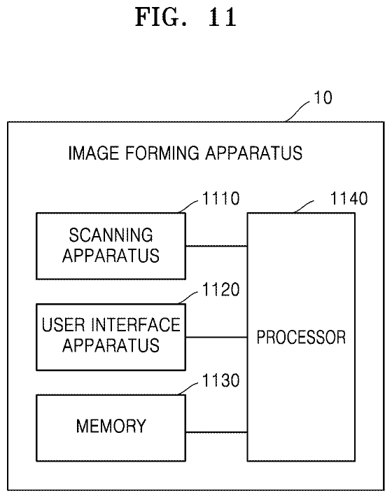

FIG. 11 is a block diagram illustrating an image forming apparatus, according to an example.

Referring to FIG. 11, the image forming apparatus 10 may include a scanning apparatus 1110, a user interface apparatus 1120, a memory 1130, and a processor 1140. However, the illustrated components are not mandatory components. The image forming apparatus 10 may be implemented by more components, and the image forming apparatus 10 may be implemented by fewer components. Hereinafter, the illustrated components will be described.

The scanning apparatus 1110 may, according to a request for a preset scan job, perform a preset scan job and generate a scan image in the image forming apparatus 10. For example, the scanning apparatus 1110 may include an automatic document feeder (ADF) for automatic supply of documents.

The user interface apparatus 1120 may include an input unit for receiving an input for controlling an operation of the image forming apparatus 10 from a user, and an output unit for displaying information such as a result of an operation of the image forming apparatus 10 or a state of the image forming apparatus 10. For example, the user interface apparatus 1120 may include an operation panel for receiving user input, a display panel for displaying a screen, or the like.

As an example, the input unit may include a device capable of receiving various types of user input, for example, a keyboard, a physical button, a touch screen, a camera, a microphone, or the like. In addition, the output unit may include, for example, a display panel, a speaker, or the like. However, it is not limited thereto, and the user interface apparatus 1120 may include a device supporting various input/output.

The memory 1130 may store software or programs. The memory 1130 may store a program related to the operation of the image forming apparatus 10 such as an operation for displaying a screen for setting a coating area based on identification information of an object in a printout, obtaining coating-area information based on user input, performing a printout coating job according to the coating-area information, or the like.

The processor 1140 may execute a program stored in the memory 1130, read data or a file stored in the memory 1130, store a new file in the memory 1130, or the like. The processor 1140 may execute instructions stored in the memory 1130.

The scanning apparatus 1110 may perform a scan job on a first printout, and the processor 1140 may obtain identification information including type information and area information of an object in the first printout based on the scan job.

For example, the type of an object may include an image, a text, a registered keyword, a registered image, or the like. For example, the area information of an object may include information about an area representing an effective area of the object within a printout. For example, in a case where the image and text are included in the first printout, the processor 1140 may obtain the image and the text as object type information of the first printout. In addition, processor 1140 may obtain an area where the image is located in the first printout as area information of the image, and obtain the area where the text is located in the first printout as area information of the text.

For example, the processor 1140 may detect objects by object type in the first printout, based on read information obtained by a scan job of the first printout. The processor 1140 may obtain area information indicating an effective area of an object within the first printout by object type.

In an example, the processor 1140 may change analog information of the first printout to digital information, based on the scan job of the first printout. The processor 1140 may analyze digital information of the first printout through OCR in the image forming apparatus 10, thereby obtaining, by object type, area information corresponding to an object in the first printout. For example, OCR may refer to an apparatus to read text or the like recorded in a preset printout using light. In addition, a program having an OCR function may be installed in the image forming apparatus 10.

For example, the processor 1140 may analyze digital information of the first printout through OCR, and may thereby detect, according to a type of a preset object, an effective area where the object is located, and obtain area information indicating information of the effective area where the object is located.

As an example, the processor 1140 may detect an image area within the first printout, and may obtain first area information corresponding to the image area. In addition, the processor 1140 may detect a text area in the first printout, and may obtain second area information corresponding to the text area. In addition, the processor 1140 may detect a keyword area in the first printout, and may obtain third area information corresponding to the keyword area.

For example, the processor 1140 may generate, by object type, a mask in which area information is identified. For example, the processor 1140 may generate a first mask in which first area information corresponding to an image area is identified, a second mask in which second area information corresponding to a text area is identified, and a third mask in which third area information corresponding to a keyword area is identified. The memory 1130 may store masks generated by object type.

The processor 1140 may display an execution screen for setting an area in which a coating job is to be performed, through the user interface apparatus 1120, based on identification information of an object.

For example, the user interface apparatus 1120 may display a plurality of pieces of option information used for setting an area in which a first coating job is to be performed, based on the type information of the object. The user interface apparatus 1120 may display a plurality of pieces of option information used for setting an area in which a coating job is to be performed, based on object type information. For example, in a case where images and text are included in the first printout, the user interface apparatus 1120 may provide optional information for setting the image area and the text area as an area in which the coating job is to be performed. In addition, in a case where a preset keyword is included in the first printout, the user interface apparatus 1120 may provide optional information for setting the keyword area as an area in which a coating job is to be performed. In addition, in a case where the first printout is a printout in a preset format, the image forming apparatus 10 may provide optional information for setting a coating area set in a printout in a preset format as an area in which a coating job is to be performed.

The user interface apparatus 1120 may display, on a preview image of the first printout, area information of an object or an interface for setting an area. For example, the user interface apparatus 1120 may display the preview image of the first printout of which areas are divided by object type. In addition, the user interface apparatus 1120 may display an interface for setting an area in which a first coating job is to be performed on the preview image of the first printout.

For example, the processor 1140 may recommend a coating job for the first printout, based on read information obtained with a scan job of the first printout.

The processor 1140 may obtain first coating-area information of an area in which a first coating job is to be performed within the first printout, based on a user input which has been input through an execution screen.

For example, the user interface apparatus 1120 may receive an input for selecting option information among a plurality of pieces of option information. The processor 1140 may obtain first coating-area information of the first printout, based on an effective area identified as an area corresponding to the option information.

For example, in a case where there is more than one selected option information, the processor 1140 may obtain masks identified as an area of an object corresponding to the selected option information. The processor 1140 may combine the masks to obtain first coating-area information of the first printout.

The processor 1140 may perform the first coating job on the first printout, according to the first coating-area information.

For example, the processor 1140 may obtain first coating-level information for an area in which the first coating job is to be performed within the first printout. The first coating-level information may be information indicating a coating thickness for the area. The processor 1140 may perform a coating job on the first printout, based on the first coating-area information and the first coating-level information.

For example, the user interface apparatus 1120 may display information that guides a mounting direction of the first printout. In a case where a printout is mounted on a tray for a coating job in the image forming apparatus 10, the processor 1140 may perform a first coating job on the first printout, based on the first coating-area information.

In an example, the image forming apparatus 10 may further include a communication apparatus (not shown). The communication apparatus (not shown) may communicate with an external apparatus. For example, the communication apparatus (not shown) may be connected to a network by wire or wirelessly to perform communication with an external apparatus. Here, the external apparatus may be an external server that manages the image forming apparatus 10, and may be an electronic apparatus (e.g., transceiver) that requests a preset job from the image forming apparatus 10. The communication apparatus (not shown) may include a communication module supporting one of various wired and wireless communication methods. For example, the communication module may also be a short-range communication module or a wired communication module.

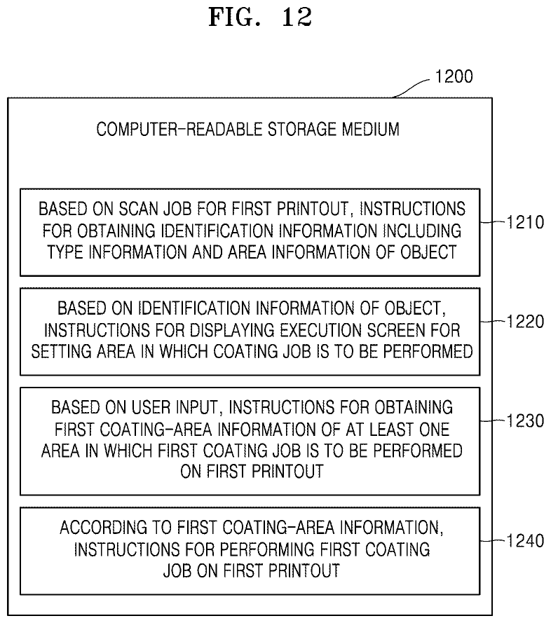

FIG. 12 is a diagram for explaining instructions stored in a computer-readable storage medium, according to an example.

Referring to FIG. 12, a computer-readable storage medium 1200 may store instructions related to an operation of the image forming apparatus 10 described with reference to FIGS. 1 to 11. For example, the computer-readable storage medium 1200 may store instructions 1210 for obtaining identification information including type information and area information of an object, based on a scan job of the first printout, instructions 1220 for displaying an execution screen for setting an area where a coating job is to be performed, based on the identification information of the object, instructions 1230 for obtaining first coating-area information of an area in which a first coating job is to be performed in a first printout, based on a user input, and instructions 1240 for performing the first coating job on the first printout, according to the first coating-area information.

Example operating methods of the image forming apparatus 10 described above may be implemented in the form of a non-transitory computer-readable storage medium that stores instructions or data executable by a computer or processor. An example operating method of the image forming apparatus 100 described above may be written as a program that may be executed on a computer, and may be implemented in a general-purpose digital computer that operates such a program using a non-transitory computer-readable storage medium. Such a non-transitory computer-readable storage medium may be any device capable of storing information such as read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, a hard disk, a solid-state disk (SSD), instructions or software, associated data, data files, and data structures, and providing instructions or software, associated data, data files, and data structures to a computer such that the processor or the computer may execute an instruction.

Although examples have been described above, various modifications and variations may be made from the above description. For example, even if the described techniques are performed in a different order than the described method, and/or the components of the described system, structure, device, circuit, etc. are joined or combined in a different form from that described, or are replaced or substituted by other components or equivalents, appropriate results can be achieved.

It should be understood that examples described herein should be considered in a descriptive sense only and not for purposes of limitation. Descriptions of features or aspects within each example should typically be considered as available for other similar features or aspects in other examples. While examples have been described with reference to the figures, it will be understood that various changes in form and details may be made therein without departing from the spirit and scope as defined by the following claims.

What is claimed is:

1. An operating method comprising:
obtaining, based on a scan job for a first printout, identification information including type information and area information of an object in the first printout;
displaying, based on the identification information of the object, an execution screen for setting an area in which a coating job is to be performed;
obtaining, based on a user input received through the execution screen, first coating-area information of an area in which a first coating job is to be performed within the first printout; and
performing the first coating job on the first printout according to the first coating-area information.

2. The operating method of claim 1, wherein the obtaining of the identification information of the object comprises:
detecting, based on read information obtained by the scan job performed on the first printout, an object by type of the object in the first printout; and
obtaining, by the type of the object, area information indicating an effective area of the object within the first printout.

3. The operating method of claim 1, wherein a type of the object comprises an image type, a text type, a registered keyword type, or a registered image type.

4. The operating method of claim 2, wherein the obtaining of, by the type of the object, area information indicating the effective area of the object comprises:
generating, by the type of the object, a mask in which the area information is identified; and
storing the mask generated by the type of the object.

5. The operating method of claim 1, wherein the displaying of the execution screen for setting the area in which the coating job is to be performed, based on the identification information of the object, comprises:
displaying, based on the type information of the object, a plurality of pieces of option information used for setting the area in which the first coating job is to be performed; and
displaying, on a preview image of the first printout, the area information of the object or an interface for setting the area.

6. The operating method of claim 5, wherein the obtaining of the first coating-area information based on the user input comprises:
receiving an input for selecting a piece of option information among the plurality of pieces of option information; and
obtaining the first coating-area information of the first printout, based on an effective area identified as an area corresponding to the piece of option information.

7. The operating method of claim 6, wherein the obtaining of the first coating-area information based on the user input comprises:
in a case where the selected piece of option information includes two or more pieces, obtaining a mask for each area of an object corresponding to the selected pieces of option information; and
obtaining the first coating-area information of the first printout by combining the masks.

8. The operating method of claim 1, wherein the performing of the first coating job on the first printout according to the first coating-area information comprises:
obtaining first coating-level information for the area in which the first coating job is to be performed within the first printout, the first coating-level information indicating a coating thickness of the area; and
performing the first coating job on the first printout, based on the first coating-area information and the first coating-level information.

9. The operating method of claim 1, wherein the performing of the first coating job on the first printout according to the first coating-area information comprises:
displaying information for guiding a mounting direction of the first printout; and
in a case where the printout is mounted on a tray for a coating job, performing the first coating job on the first printout, based on the first coating-area information.

10. The operating method of claim 1, further comprising, in a case where a scan job is performed on a second printout, recommending a second coating job for the second printout, based on read information of the second printout.

11. The operating method of claim 10, wherein the recommending of the second coating job for the second printout comprises, based on the read information of the second printout, in response to confirmation that the second printout is a printout in a preset format, recommending the second coating job to coat a preset area.

12. The operating method of claim 10, wherein the recommending of the second coating job for the second printout comprises, based on the read information of the second printout, in response to confirmation that the second printout includes a preset keyword or a preset image, recommending the second coating job to coat an area corresponding to the preset keyword or the preset image.

13. A non-transitory computer-readable storage medium having stored therein instructions executable by a processor, the computer-readable storage medium comprising:
instructions to obtain identification information including type information and area information, based on a scan job performed on a first printout, by type of object in the first printout;
instructions to display, based on identification information of the object, an execution screen for setting an area in which a coating job is to be performed;
instructions to obtain, based on a user input received through the execution screen, first coating-area information of an area in which a first coating job is to be performed within the first printout; and
instructions to perform the first coating job on the first printout, according to the first coating-area information.

14. An image forming apparatus comprising:
a scanning apparatus;
a user interface apparatus;
a processor; and
a memory to store instructions executable by the processor,
wherein the processor is to execute the instructions to:
obtain, based on a scan job performed on a first printout through the scanning apparatus, identification information including type information and area information of an object in the first printout;
display, on the user interface apparatus, an execution screen for setting an area where a coating job is to be performed, based on the identification information of the object;
obtain, based on a user input received through the execution screen, first coating-area information of an area in which a first coating job is to be performed within the first printout; and
perform the first coating job on the first printout, according to the first coating-area information.

15. The image forming apparatus of claim 14, wherein the processor is to execute the instructions to:
display, on the user interface apparatus, a plurality of pieces of option information used to set the area in which the first coating job is to be performed, based on the type information of the object,
receive, through the user interface apparatus, an input for selecting a piece of option information among the plurality of pieces of option information, and
obtain the first coating-area information of the first printout, based on an effective area identified as an area corresponding to the piece of option information.
